(19) United States
(12) Patent Application Publication
(10) Pub. No.: US 2025/0297643 A1
(43) Pub. Date: Sep. 25, 2025

(54) MOLDED CAGE FOR ROLLING BEARINGS AND RELATED ROLLING BEARING UNIT

(71) Applicant: AKTIEBOLAGET SKF, GOTEBORG (SE)

(72) Inventor: Leonardo CATANA, Chieri (IT)

(21) Appl. No.: 19/079,702

(22) Filed: Mar. 14, 2025

(30) Foreign Application Priority Data
Mar. 25, 2024 (IT) 102024000006589

(51) Int. Cl. F16C 33/38

(52) U.S. Cl. CPC F16C 33/3887

(57) ABSTRACT

A rolling bearing unit includes a rolling bearing and an annular cage including an annular body molded from a synthetic plastic material and a plurality of seats or pockets to accommodate the respective rolling bodies. The annular body has a radially outer annular lateral surface including an annular shallow recess extending axially between a pair of opposing end edges of the annular body and a pair of annular guide reliefs designed to cooperate when in use with an outer ring of a bearing. The radially outer lateral surface of the annular body is provided with a plurality of sets of four recesses arranged around each one of the plurality of pockets, each recess preferably being formed as a blind recess.

### CROSS-REFERENCE

This application claims priority to Italian patent application no. 102024000006589 filed on Mar. 25, 2024, the contents of which are fully incorporated herein by reference.

### BACKGROUND OF THE INVENTION

The present invention relates to a cage for rolling bearings made by injection (or compression) molding of a synthetic plastic resin, as well as to a related rolling bearing unit, including such a cage, molded from a synthetic plastic material.

A rolling bearing comprising an outer ring, an inner ring and a plurality of rolling bodies (for example balls) interposed between the inner and outer rings to make them relatively rotatable with low friction is known. The rolling bodies, whether arranged in a single row of rolling bodies, or in a pair of adjacent rows of rolling bodies, are held in the correct position by a cage, referred to as a “spacer cage”.

Nowadays, such cages for holding the rolling bodies are usually made of a synthetic plastic material, for example a phenolic resin or a polyamide or another suitable synthetic material.

In precision or high-speed rolling bearings, the cage is usually guided on its radially outer diameter, i.e. there is/may be contact between radially outermost portions of the cage and part of the radially inner lateral surface of the outer ring of the rolling bearing.

In such types of rolling bearings, in order to avoid excessive friction and in particular to hold the cage and rolling bodies in a correct radial position, the plastic cages cannot be made by molding, but must be made by machining tubes or tubular stock, typically by turning and milling. In fact, this type of production process means that molded cages cannot currently achieve manufacturing tolerances comparable to cages made by machining.

As a result, plastic cages are relatively expensive to make and have relatively long manufacturing times. Furthermore, the current design of the plastic cages made by machining does not enable a reduction of the surface contact and the friction torque between the cage and the outer ring of the bearing.

### SUMMARY OF THE INVENTION

The present invention is intended to overcome the drawbacks of the prior art and in particular to provide a cage made of a synthetic plastic material which, although made by molding rather than by machining, has high stability and high dimensional precision, thus enabling the rolling bodies to be correctly held and to eliminate possible noise when in use, while at the same time reducing friction between the cage and the outer ring of the bearing in use, which causes unwanted heating of the bearing unit, this phenomenon occurring mainly in rolling bearings with a cage guide on the outer diameter of the cage, i.e. in bearing units in which the cage is guided on the radially inner diameter of the outer ring of the bearing.

The present invention is also intended to provide a rolling bearing unit including such a cage.

Therefore, the present invention provides a cage for holding the rolling bodies in a rolling bearing, and a related rolling bearing unit, as defined herein and in the attached claims.

The present invention is based on designing the cage, in particular the radially outer lateral portion thereof, with reduced contact surfaces in order to reduce friction and therefore undesired heating, and cage walls of constant section, enabling greater control over the shrinkage of the plastic material during and after the molding phase.

### BRIEF DESCRIPTION OF THE SEVERAL VIEWS OF THE DRAWINGS

Further features and advantages of the present invention are set out more clearly in the following description of non-limiting embodiments thereof, provided with reference to the figures in the attached drawings, in which:

FIG. 1 is a schematic longitudinal three-quarter perspective view of a cage for holding rolling bodies that can be fitted to a rolling bearing and manufactured according to the invention;

FIG. 2 is a schematic magnified perspective view of a circumferential portion of a radially outer annular lateral face of the cage in FIG. 1;

FIG. 3 is a schematic radial cross-section view of a rolling bearing unit according to the invention, comprising, in the non-limiting example illustrated, a rolling bearing with a single row of rolling bodies, shown as balls in the non-limiting illustration, and the cage for holding the rolling bodies in FIG. 1;

FIG. 4 is a schematic magnified longitudinal elevation view of the rolling bearing unit in FIG. 3 with the outer ring of the rolling bearing removed and the rolling bodies illustrated using thin lines;

FIG. 5 is a schematic longitudinal cross-section elevation view of the cage according to the invention and illustrated in FIG. 1;

FIG. 6 is a schematic highly magnified view of a detail of the cross-section of a radial portion of the cage in FIG. 5, showing further details of the respective radially outer and radially inner lateral surfaces of the cage in FIGS. 1 and 5;

FIG. 7 is a schematic highly magnified longitudinal view of a portion of the cage in FIGS. 1 and 5 viewed radially from the outside;

FIG. 8 is a schematic magnified radial cross-section view of a circumferential portion of the cage in FIGS. 1 and 5 according to the invention; and

FIG. 9 is a schematic magnified view of a detail of a circumferential portion of the rolling bearing unit in FIG. 3.

### DETAILED DESCRIPTION OF THE INVENTION

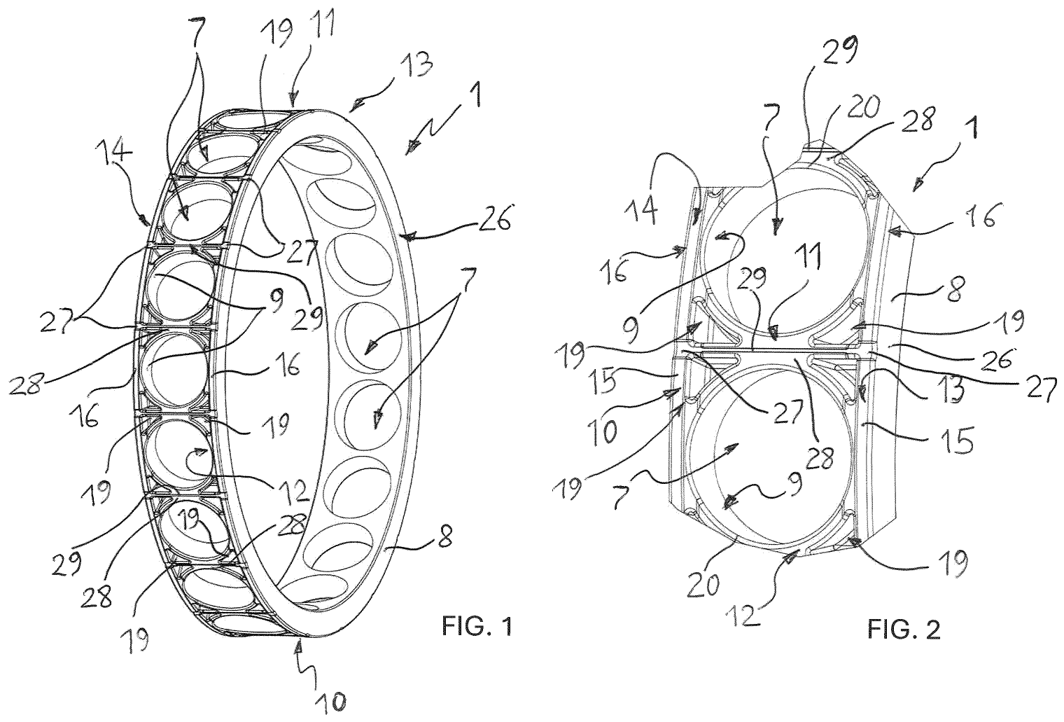

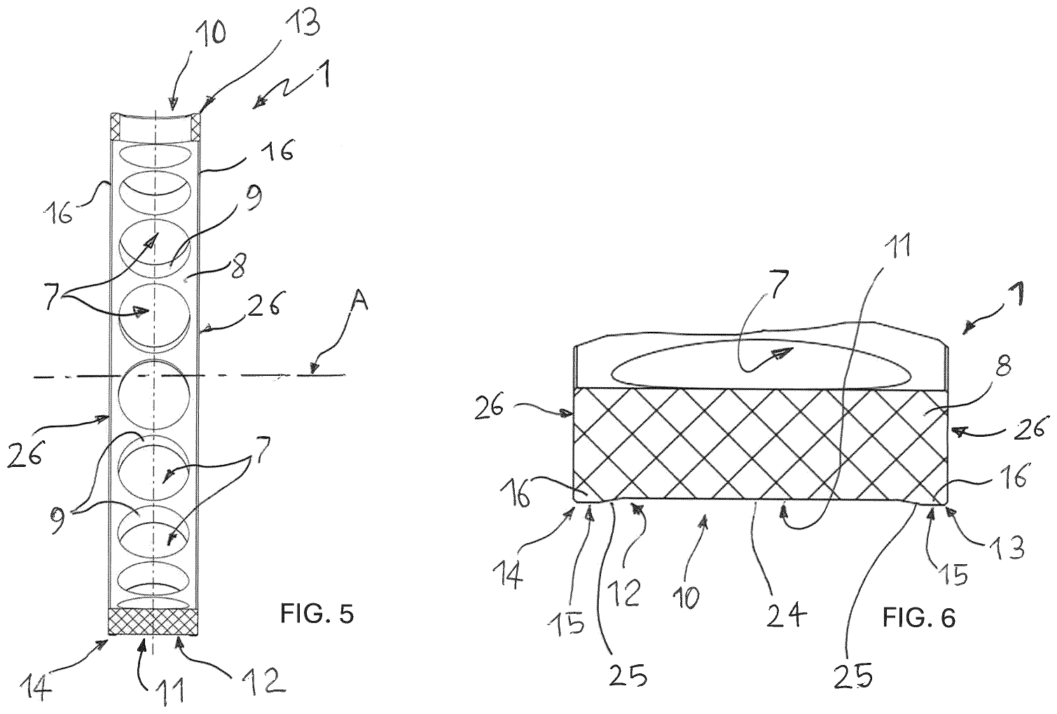

In FIGS. 1 to 7, reference sign 1 indicates, as a whole, a cage for holding rolling bodies 2 in a rolling bearing 3.

The rolling bearing 3 comprises an outer ring 4, an inner ring 5, and a plurality of rolling bodies 2 interposed between the outer ring 4 and the inner ring 5 to make them relatively rotatable with low friction, i.e., the bodies 2 rotatably couple the two rings 4, 5, and forms a rolling bearing unit 6 with the cage 1 interposed between the outer ring 4 and the inner ring 5.

The cage 1 is therefore designed to be interposed or disposed between the respective inner ring 5 and outer ring 4 of the rolling bearing 3 when in use to hold, in a known manner, the rolling bodies 2 in the correct position between the rings 4 and 5, with the desired pitch between the rolling bodies 2, the rolling bodies 2 being depicted as balls in the illustrated, non-limiting example.

The annular cage 1 has an axis of symmetry A that is coincident, when in use, with the axis of symmetry of the rolling bearing 3, and is also the axis of symmetry of the rolling bearing unit 6. The axis A is also the axis of relative rotation between the rings 4 and 5.

The cage 1 comprises an annular body 8 provided with a plurality of radially through seats or pockets 7 arranged in a row about the axis A, each being designed to accommodate a respective rolling body 2.

The seats or pockets 7 are bounded by an enclosed inner lateral surface 9, which can be cylindrical, making each one of the seats or pockets 7 simple radial through-holes formed or extending through the body 8, but may be partially spherical or any other appropriate shape.

The annular body 8 has a radially outer annular lateral surface 10 which bounds the annular body 8 radially on the outside and which is traversed by the seats or pockets 7.

According to a first aspect of the invention, the radially outer annular lateral surface 10 includes a substantially channel-shaped concave annular middle portion 11 consisting of an annular shallow recess 12 formed radially on the outside of the annular body 8 and extending symmetrically, in an axial direction, between a pair of opposing end edges 13 and 14 of the annular body 8.

The radially outer annular lateral surface 10 also comprises a pair of substantially cylindrical opposing annular surface portions 15 (FIG. 6), which delimit, radially towards the outside, respective annular reliefs 16 for guiding the annular body 8 that are formed at the end edges 13 and 14 of the annular body 8.

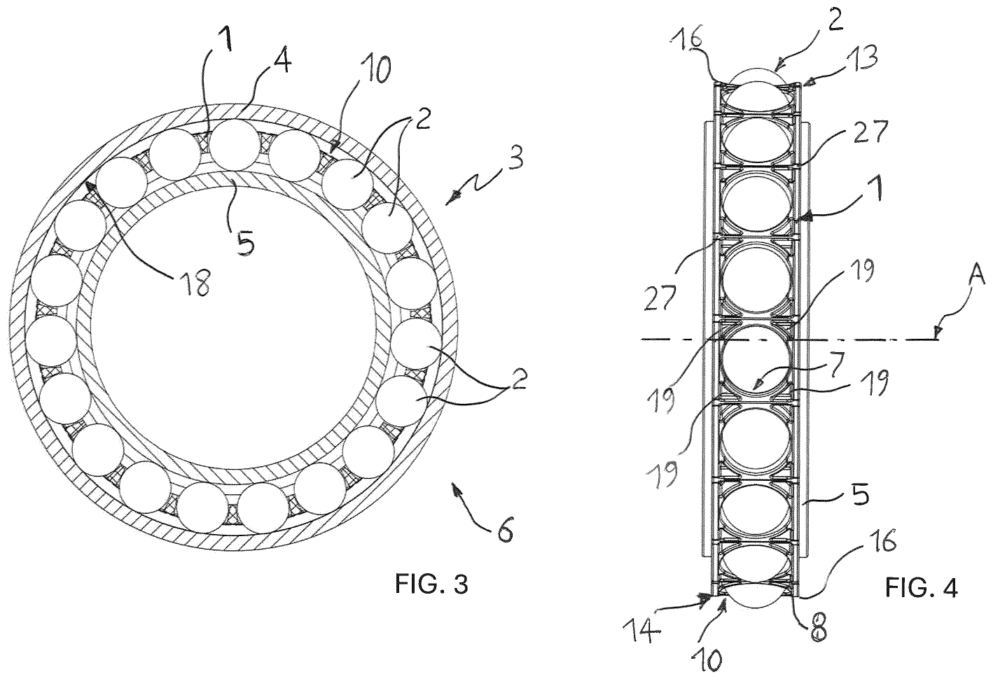

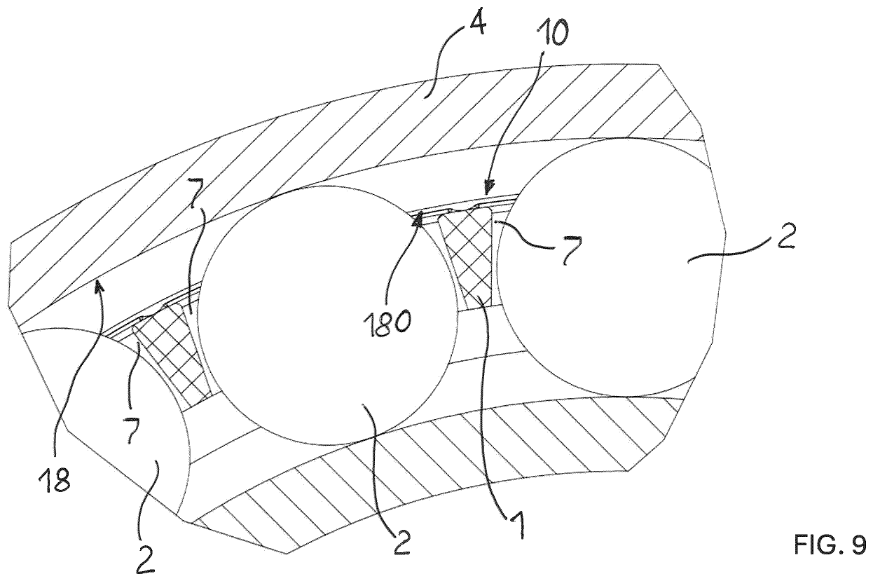

The annular guide reliefs 16 are designed to cooperate, when in use, with the outer ring 4 of the rolling bearing, in particular with respective substantially cylindrical axial-end annular surface portions 180 (FIG. 9) of a radially inner lateral surface 18 (FIG. 3), which is also substantially cylindrical, of the outer ring 4 of the rolling bearing 3, the raceway (not indicated) for the rolling bodies 2 being formed on the surface 18.

The seats or pockets 7 are formed through the concave annular middle portion 11 of the radially outer lateral surface 10 of the annular body 8.

According to a further and important aspect of the invention, each one of the seats or pockets 7 is flanked by a set of four recesses 19 (FIGS. 1, 2, 7 and 8) which are substantially identical or identically formed, circumscribed to the respective seat or pocket 7 and also formed in the concave annular middle portion 11 of the radially outer lateral surface 10 of the annular body 8.

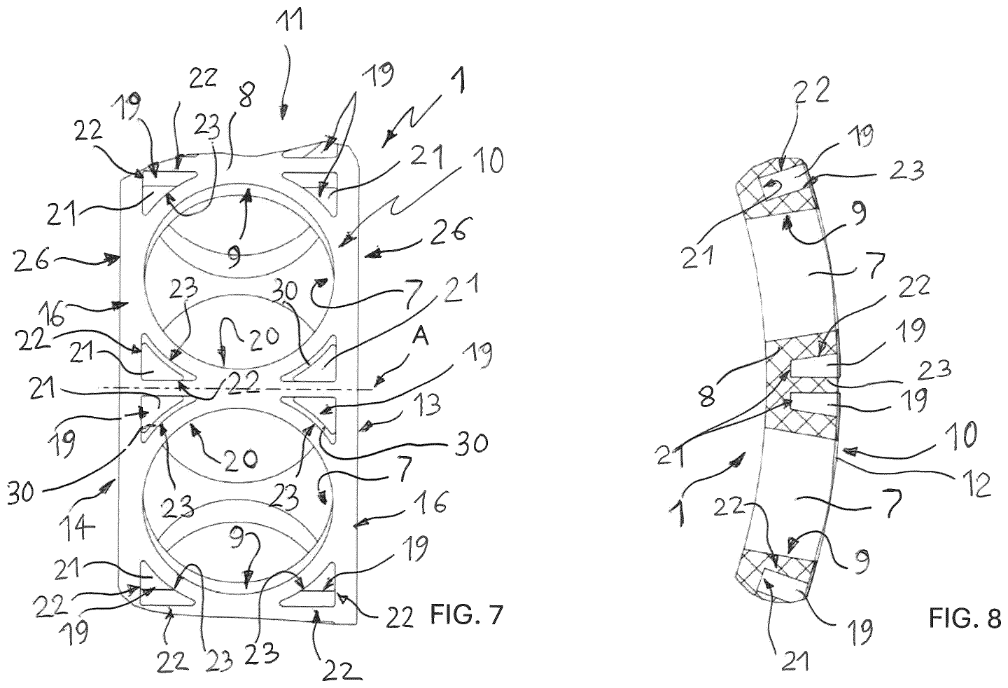

The recesses 19 are arranged symmetrically, in diagonally opposing positions, around each seat or pocket 7 and are each formed between a peripherally outer circular edge 20 of the respective seat or pocket 7 and a respective annular relief 16 (FIGS. 2 and 7).

The recesses 19, which are therefore formed inside part of the annular body 8, define blind concavities, i.e. not through-concavities, on the concave annular middle portion 11 of the radially outer lateral surface 10 of the annular body 8.

In fact, each recess 19 is bounded (FIGS. 7 and 8) by a bottom wall 21 and by respective lateral walls 22 and 23 arranged transversely to the bottom wall 21 and to the surface of the concave annular middle portion 11 of the radially outer lateral surface 10 of the annular body 8.

The bottom walls 21 of all the recesses 19 are preferably made as flat surfaces, oriented as chords of the lateral annular surface 10 of the body 8 molded from synthetic plastic material.

The recesses 19 defining blind concavities on the lateral surface 10 are designed to have, in a plan view from a direction radial to the axis of symmetry A (FIGS. 2 and 7), a substantially right-angle-triangle shape, a first and a second of the lateral walls 22 of the recesses 19 circumscribed to each seat or pocket 7 are adjacent to each other and form or substantially form a right angle, so as to define the legs of the right-angle triangle formed in plan view by each recess 19.

A first lateral wall 22 of each recess 19 circumscribed to a respective seat or pocket 7 is arranged immediately adjacent to one of the annular reliefs 16 and a second lateral wall 22 of the same recess 19 is arranged immediately adjacent to a corresponding second lateral wall 22 of a different recess 19 that is circumscribed to another seat or pocket 7 immediately adjacent thereto.

A third lateral wall 23 of each recess 19 substantially defining the hypotenuse of the right-angle triangle defined by the recess 19 is arranged immediately adjacent to the peripherally outer circular edge 20 of a respective seat or pocket 7 to which the recess 19 is circumscribed.

The first and second lateral walls 22 of each recess 19 consist of a flat surface, while the third lateral wall 23 of each recess 19 consists of a curved surface, preferably defined by a cylindrical or spherical surface.

Furthermore, according to one aspect of the invention, the first and second lateral walls 22 and the third lateral wall 23 of each recess 19 are arranged obliquely to the axis of symmetry A, so as to approach each other towards the bottom wall 21. In other words, the recesses 19 are tapered towards the axis A.

Preferably, the recesses 19 defining the blind concavities on the concave annular middle portion 11 of the radially outer lateral surface 10 of the annular body 8 have a depth, measured in a radial direction with respect to the axis of symmetry A, of at least half the radial thickness, also measured in a radial direction with respect to the axis of symmetry, of the annular body 8 and preferably approximately two thirds of the radial thickness of the annular body 8.

Indeed, testing has shown that the aforementioned dimensions, together with the shape and positioning described, optimize the functional efficiency of the recesses 19.

Indeed, the blind recesses 19 are not merely intended to reduce the weight of the annular body 8, but also, together with the specific shape of the radially outer lateral surface 10 of the annular body 8, allow the shrinkage of the molded synthetic plastic material forming the annular body 8 to be reduced and controlled, such shrinkage occurring after molding as a result of the cooling of the synthetic plastic material. Above all, the recesses 19 ensure that the walls of the cage 1 are of constant section, allowing a more controlled shrinkage of the plastic material during and after the molding phase.

With specific reference to FIG. 6, the concave annular middle portion 11 of the radially outer annular lateral surface 10 of the annular body 8, which consists of the annular shallow recess 12 formed radially on the outside of the annular body 8 and therefore substantially channel-shaped, is bounded by a flat annular bottom wall 24 and by two substantially flat opposing annular lateral walls 25 arranged obliquely in relation to the flat annular bottom wall 24 so as to converge with each other towards the axis of symmetry A.

The oblique annular lateral walls 25 are preferably connected continuously to the flat annular bottom wall 24.

The annular reliefs 16 for guiding the annular body 8, which are formed at the end edges 13, 14 of the annular body 8, are substantially flush with respective flat continuous axial end faces 26 of the annular body 8, which are substantially free of concavities and which bound the end edges 13, 14 of the annular body 8 axially toward the outside and on opposite sides.

The reliefs 16 thus simultaneously ensure optimal guidance of the cage 1 and reduce the contact surfaces with the outer ring 4, i.e., the surface area of the cage 1 contacting the outer ring 4, thereby reducing friction and consequently unwanted heating and energy consumption.

According to a preferred aspect of the present invention, the annular reliefs 16 are provided with a plurality of first axially oriented transverse grooves 27 (FIGS. 1 and 2), formed in facing pairs, at the opposing end edges 13, 14 of the annular body 8.

The grooves 27 of each pair are axially aligned with each other and each pair of opposing facing transverse grooves 27 is arranged at least partially discontinuously (i.e. also not over the entire radial extension) of the annular reliefs 16.

In particular, the grooves 27 are arranged at respective circumferential portions 28 (FIG. 2) of the annular body 8 which axially connect the end edges 13, 14 of the annular body 8 to each other and which separate the seats or pockets 7 of the annular body 8 at a substantially constant pitch.

The substantially channel-shaped concave annular middle portion 11 of the radially outer annular lateral surface 10 of the annular body 8 radially bounds each circumferential portion 28 on the outside and is also provided with a plurality of second axial grooves 29 (FIG. 2) which pass across the outer lateral surface 10 transversely and which are each formed level with a separate one of the pairs of axially oriented transverse grooves 27, along the entire corresponding circumferential portion 28 of the annular body 8.

The second axial grooves 29 are aligned with the first axially oriented transverse grooves 27 and are designed to hydraulically or fluidly connect them together.

The grooves 27 are intended to prevent burrs from forming during molding and subsequent removal (from the mold) of the annular body 8, whereas the grooves 29 facilitate the circulation of lubricating grease, by centrifugal force, inside the rolling bearing 3.

Finally, the lateral walls 23 are in particular provided with chamfers 30 substantially flush with the central concave surface portion 11 of the radially outer lateral surface 10 of the annular body 8, which are intended to facilitate the molding and, in particular, the removal of the annular body 8 from the related mold, immediately after injection molding thereof (not shown for simplicity).

All of the objectives of the invention are thus achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. An annular cage for retaining rolling bodies in a rolling bearing, the rolling bearing including an inner ring, an outer ring and a plurality of rolling bodies, the annular cage comprising:
an annular body having an axis of symmetry, being formed of a synthetic plastic material and being configured to be disposed between the inner ring and the outer ring, a plurality of pockets each extending radially through the annular body and arranged in a row around the axis of symmetry, each pocket being configured to accommodate a separate one of the plurality of rolling bodies, the annular body further having opposing end edges and a radially outer annular lateral surface bounding the body radially on the outside and traversed by the pockets;
wherein the radially outer annular lateral surface includes:
a concave annular middle portion shaped substantially like a channel and consisting of an annular shallow recess provided radially on the outside of the annular body and extending symmetrically, in an axial direction, between the pair of opposing end edges of the annular body; and
a pair of opposing, substantially cylindrical annular surface portions which radially outwardly bound respective annular guiding reliefs of the annular body provided at the end edges of the annular body, the annular guiding reliefs being configured to cooperate with the outer ring of the rolling bearing.

2. The annular cage according to claim 1, wherein the plurality of pockets are formed through the concave annular middle portion of the radially outer lateral surface of the annular body, each pocket being flanked by a separate set of four recesses formed in the concave annular middle portion of the radially outer lateral surface of the annular body, each recess of each set of four recesses being substantially identically formed and each set of recesses being arranged symmetrically about a separate one of the plurality of pockets, each recess being disposed between a peripherally outer circular edge of the pocket and one of the two annular guiding reliefs.

3. The annular cage according to claim 2, wherein each recess of each set of four recesses is formed as a blind concavity bounded by a bottom wall and lateral walls extending transversely to the bottom wall and to the concave annular middle portion of the radially outer lateral surface of the annular body.

4. The annular cage according to claim 3, wherein each recess of each set of four recesses has, in a plan view from a direction radial to the axis of symmetry, a substantially right-angled triangle shape, and includes a first lateral wall, a second lateral wall and a third lateral wall, the first and second lateral walls defining the legs of the right-angled triangle, the first lateral wall being arranged adjacent to one of the two annular guiding reliefs, the second lateral wall being arranged adjacent to a corresponding second lateral wall of an adjacent recess disposed about an adjacent pocket, and the third lateral wall substantially defining the hypotenuse of the right-angled triangle and being arranged adjacent to the peripherally outer circular edge of the pocket circumscribed by the set of four recesses.

5. The annular cage according to claim 4, wherein each one of the first and second lateral walls of each recess has a flat surface and the third lateral wall of each recess has a curved surface.

6. The annular cage according to claim 5, wherein the curved surface of the third lateral wall is cylindrical or spherical.

7. The annular cage according to claim 4, wherein the first, second and third lateral walls of each recess is arranged obliquely to the axis of symmetry.

8. The annular cage according to claim 3, wherein each recess of each set of four recesses has a depth measured in a radial direction with respect to the axis of symmetry, the depth being equal to at least half of a radial thickness of the annular body measured in a radial direction with respect to the axis of symmetry.

9. The annular cage according to claim 1, wherein the concave annular middle portion of the radially outer annular lateral surface of the annular body is bounded by a flat annular bottom wall and by two opposite annular lateral walls, each annular lateral wall being substantially flat and arranged obliquely to the flat annular bottom wall so as to converge with each other toward the axis of symmetry, the two annular lateral walls being connected continuously with the flat annular bottom wall.

10. The annular cage according to claim 1, wherein the annular body has opposing axial end faces, each axial end face being flat and continuous and axially outwardly bounding a separate one of the end edges of the annular body, the annular guiding reliefs formed at the end edges of the annular body are arranged substantially flush with a separate one of the axial end faces of the annular body, the annular guiding reliefs being provided with a plurality of axially oriented transverse first grooves formed in pairs, facing each other, at opposite end edges of the annular body and aligned with each other axially, each first groove of each pair of first grooves being arranged to at least partially interrupt a separate one of the annular reliefs at respective circumferential portions of the annular body axially connecting with each other the end edges of the annular body and separating from each other the pockets of the annular body with a substantially constant spacing.

11. The annular cage according to claim 10, wherein the concave annular middle portion of the radially outer annular lateral surface of the annular body is provided with a plurality of second axial grooves extending transversally across the concave annular middle portion and each formed at a separate one of the plurality of the pairs of axially oriented transverse first grooves, each one of the plurality of second axial grooves being axially aligned with the one pair first axially oriented transverse grooves and being configured to fluidly connect the two first grooves of each pair of first grooves.

12. A rolling bearing unit comprising:
a rolling bearing including an outer ring, an inner ring, and a plurality of rolling bodies disposed between and rotatably coupling the outer ring and the inner ring; and
an annular cage according to claim 1, each one of the plurality of rolling bodies being retained within a separate one of the plurality of pockets of the annular cage, the annular guiding reliefs of the annular cage cooperating with annular portions of a radially inner lateral surface of the outer ring of the rolling bearing.
